(19) United States
(12) Patent Application Publication
(10) Pub. No.: US 2026/0284843 A1
(43) Pub. Date: Sep. 24, 2026

(54) MAGNETIC ADAPTER FOR A SCREWDRIVER

(71) Applicant: Yi-Min Li, Taichung (TW)

(72) Inventor: Yi-Min Li, Taichung (TW)

(21) Appl. No.: 19/086,054

(22) Filed: Mar. 20, 2025

(51) Int. Cl. B25B 23/00

(52) U.S. Cl. CPC B25B 23/0035

(57) ABSTRACT

A screwdriver adapter includes a sleeve, a non-circular rod, two rings, a spring, a mandrel and a magnet. The sleeve includes a front non-circular hole in communication with a rear non-circular hole. The non-circular rod includes a section fitted in the rear non-circular hole and another section extending out of the rear non-circular hole. The first ring includes a larger bore in communication with and a smaller bore and is inserted in the rear non-circular hole. The second ring includes a passageway and is inserted in the rear non-circular hole. The spring is inserted in the rear non-circular hole and compressed between the rings. The mandrel includes a section fitted in the smaller bore and another section inserted in the passageway. The magnet is fitted in the larger bore. The magnet is adjacent to the mandrel, thereby magnetizing the mandrel through magnetic induction.

### BACKGROUND OF INVENTION

### 1. Field of Invention

The present invention relates to a screwdriver and, more particularly, to a magnetic adapter for a screwdriver.

### 2. Related Prior Art

Taiwanese Patent No. M308146 discloses an adapter for a screwdriver. The adapter includes a tube (10), a cup (20), a magnet (21), an internal spring (30) and a non-circular rod (40). The tube (10) includes a first non-circular bore (12) made in an end, a second non-circular bore in an opposite end, and a cave (11) through which first and second non-circular bores are in communication with each other. The non-circular rod is fitted in the second non-circular bore. The magnet is fitted in the cup, which is movable in the cave. The internal spring is inserted in the cave and compressed between the cup and the non-circular rod. The internal spring tends to move the magnet toward the bit via the first non-circular bore.

In operation, a bit of the screwdriver is inserted in the first non-circular bore, and the non-circular rod is inserted in a handle or a pneumatic or electric tool. The magnet magnetically attracts the bit. At the same time, the cup retreats in the passageway, compresses the internal spring, and keeps the cup separated from the non-circular rod by a distance. The magnet barely magnetically attracts the non-circular rod. Accordingly, the non-circular rod barely magnetically attracts the handle or the pneumatic or electric tool.

Therefore, the present invention is intended to obviate or at least alleviate the problems encountered in the prior art.

### SUMMARY OF INVENTION

It is the primary objective of the present invention to provide a screwdriver with an adapter.

To achieve the foregoing objective, the adapter includes a sleeve, a non-circular rod, two rings, a spring, a mandrel and a magnet. The sleeve includes a front non-circular hole in communication with a rear non-circular hole. The non-circular rod includes a section fitted in the rear non-circular hole and another section extending out of the rear non-circular hole. The first ring includes a larger bore in communication with and a smaller bore and is inserted in the rear non-circular hole. The second ring includes a passageway and is inserted in the rear non-circular hole. The spring is inserted in the rear non-circular hole and compressed between the rings. The mandrel includes a section fitted in the smaller bore and another section inserted in the passageway. The magnet is fitted in the larger bore. The magnet is adjacent to the mandrel, inducing magnetism in the mandrel through magnetic induction.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a magnetic adapter according to the preferred embodiment of the present invention;

FIG. 2 is an exploded view of the magnetic adapter shown in FIG. 1;

FIG. 3 is a cross-sectional view of the magnetic adapter depicted in FIG. 1;

FIG. 4 is a cross-sectional view of the magnetic adapter in another position than shown in FIG. 3;

FIG. 5 is a cross-sectional view of the magnetic adapter in another position than shown in FIG. 4; and

FIG. 6 is a cross-sectional view of the magnetic adapter in another position than shown in FIG. 5.

### DETAILED DESCRIPTION OF PREFERRED EMBODIMENT

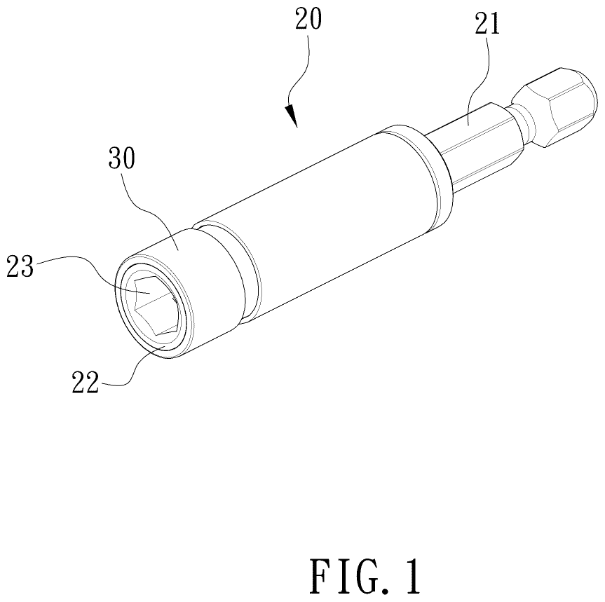

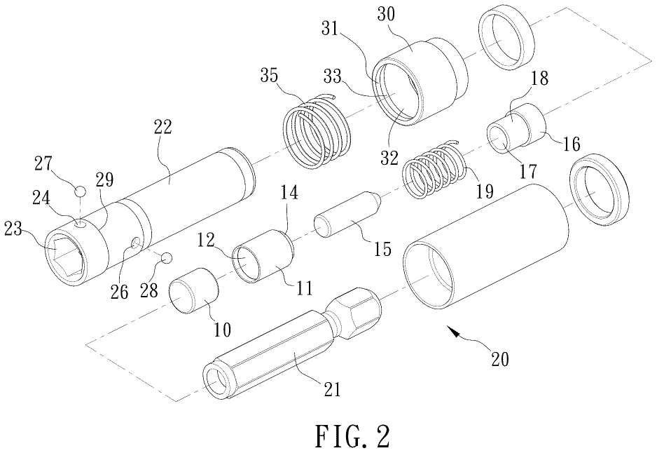

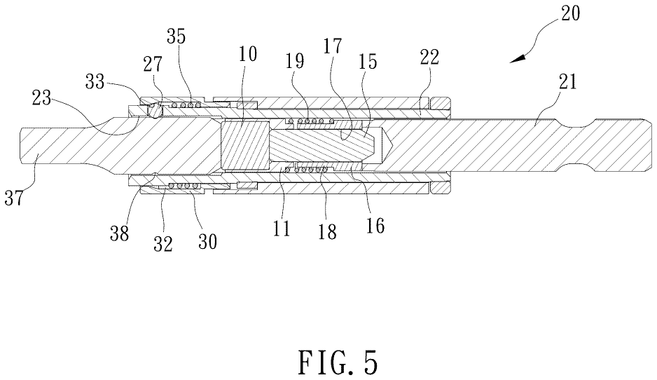

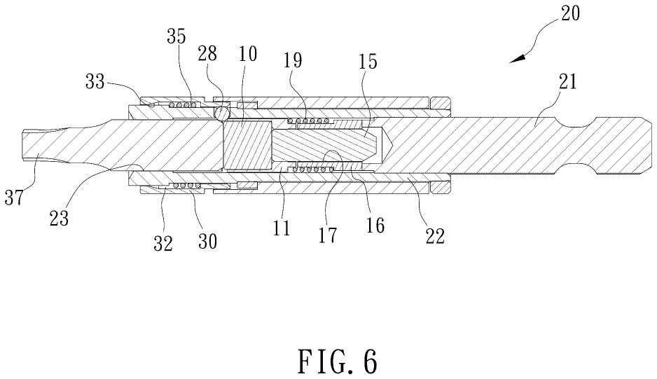

Referring to FIGS. 1 and 2, an adapter 20 includes a magnet 10, a front ring 11, a mandrel 15, a rear ring 16, a non-circular rod 21, a sleeve 22, a collar 30 and two springs 19 and 35 according to the preferred embodiment of the present invention. In operation, the adapter 20 connects a bit 37 of a screwdriver (FIGS. 5 and 6) to a handle or a hydraulic, pneumatic or electric tool.

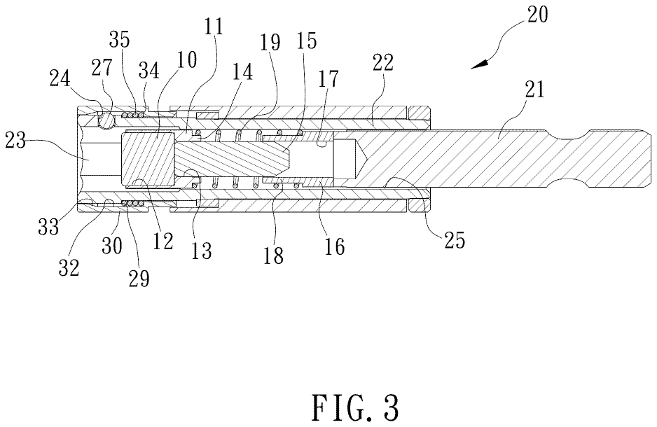

The front ring 11 includes a reduced section 14 formed at an end, thereby providing a shoulder (not numbered). The front ring 11 includes a larger bore 12 in communication with a smaller bore 13 (FIG. 3).

The rear ring 16 includes a reduced section 18 formed at an end, thereby providing a shoulder (not numbered). A passageway 17 axially extends throughout the rear ring 16.

The non-circular rod 21 is preferably a hexagonal rod. The non-circular rod 21 is insertable in a compliant non-circular bore cut in a handle or a hydraulic, pneumatic or electric tool so that the former is rotatable by the latter.

The sleeve 22 includes a non-circular hole 23 cut in a front end, a non-circular hole 25 cut in a rear end, an aperture 24 extending in a radial direction, and an orifice 26 extending in another radial direction. The non-circular holes 23 and 25 are preferably polygonal holes. A shoulder 29 extends on and around an external face of the sleeve 22 near an end.

The collar 30 includes an opening 31 cut in an end, a space 32 in communication with the opening 31 and a slope 33 extending between the opening 31 and the space 32. The diameter of the opening 31 is larger than that of the space 32 (FIG. 3). Moreover, the collar 30 includes a shoulder 34 (FIG. 3) formed on an internal face.

Referring to FIG. 3, a section of the mandrel 15 is fitted in a section of the front ring 11, i.e., in the smaller bore 13. The magnet 10 is fitted in another section of the front ring 11, i.e., in the larger bore 12. Then, the front ring 11 is movably inserted in the sleeve 22. The spring 19 is inserted in the sleeve 22. The rear ring 16 is inserted in the sleeve 22. A section of the non-circular rod 21 is fitted in the sleeve 22. The reduced section 14 of the front ring 11 is fitted in section of the spring 19. The reduced section 18 of the rear ring 16 is fitted in another section of the spring 19. The spring 19 is compressed between the shoulders of the front and rear rings 11 and 16.

In a radial sense, the spring 35 is located between the collar 30 and the sleeve 22. The spring 35 is compressed between the shoulders 34 and 29 along a common axis of the collar 30 and the sleeve 22.

The collar 30 wraps the sleeve 22. The collar 30 is movable relative to the sleeve 22.

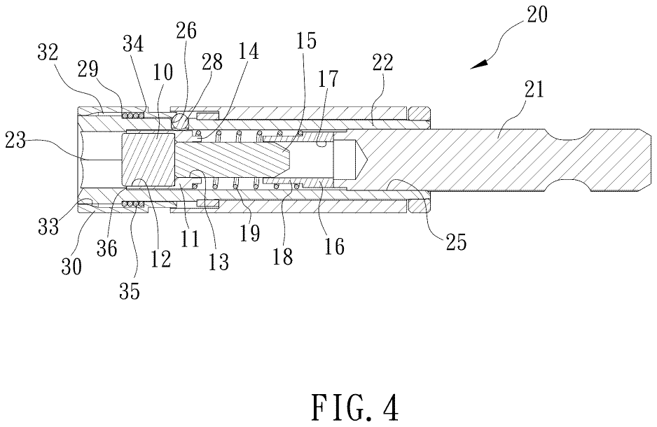

A ball 27 is movably inserted in the aperture 24. A ball 28 is movably inserted in the orifice 26 (FIG. 4).

In the present embodiment, the front ring 11 and the sleeve 22 are made of non-ferromagnetic materials such as stainless steel 302 and 304 containing high contents of chromium (Cr). Thus, the front ring 11 and the sleeve 22 are not ferromagnetic. The mandrel 15, the rear ring 16, the non-circular rod 21 and the bit 37 are made of ferromagnetic materials such as iron (Fe), nickel (Ni) and cobalt (Co). Thus, the mandrel 15, the rear ring 16, the non-circular rod 21, and the bit 37 are ferromagnetic.

The magnet 10 is in contact with the mandrel 15, thereby magnetizing the mandrel 15 through magnetic induction. The mandrel 15 is in contact with the rear ring 16, thereby magnetizing the rear ring 16 through magnetic induction. The rear ring 16 is in contact with the non-circular rod 21, thereby magnetizing the non-circular rod 21 through magnetic induction. Hence, the non-circular rod 21 magnetically attracts the handle or the hydraulic, pneumatic, or electric tool.

Moreover, the bit 37 is magnetically attracted to the magnet 10 as the bit 37 is inserted in the non-circular hole 23. Thus, the bit 37 is moved deeply in the non-circular hole 23 by the magnet 10. The front ring 11 is moved towards the non-circular rod 21. That is, the front ring 11 is moved towards the rear ring 16 so that the spring 19 is compressed. The mandrel 15 goes deeply in the passageway 17 and continues to magnetize the rear ring 16. The rear ring 16 magnetically attracts the non-circular rod 21, and the non-circular rod 21 maintains magnetic.

Referring to FIG. 4, normally, the front ring 11 is in contact with a portion of the ball 28. Another portion of the ball 28 is in contact with the collar 30.

Referring to FIG. 3, the spring 35 is compressed. A portion of the ball 27 is allowed to enter the space 32. That is, the ball 27 is allowed to completely move out of the space 32. Thus, the bit 37 is allowed to enter the space 32.

Referring to FIG. 6, the bit 37 is inserted in the space 32. The front ring 11 is moved backward. A portion of the ball 28 is allowed to enter the non-circular hole 23, stops and keeps the bit 37 in a proper position in the space 32.

Referring to FIG. 5, the spring 35 moves the collar 30 backward so that slope 33 is in contact with a first portion of the ball 27, thereby moving a second portion of the ball 27 into the non-circular hole 23. The second portion of the ball 27 enters a dent (not numbered) made in the bit 37, thereby keeping the bit 37 in the sleeve 22.

In some embodiments, the rear ring 16 is made in one piece with the non-circular rod 21, and the passageway 17 is cut deeply in the non-circular rod 21. The mandrel 15 extends deeply in the passageway 17, magnetizes the rear ring 16 and the non-circular rod 21, and does not affect the magnetic properties.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A screwdriver adapter comprising:
a sleeve comprising a front non-circular hole and a rear non-circular hole in communication with the front non-circular hole;
a non-circular rod comprising a section fitted in the rear non-circular hole and another section extending out of the rear non-circular hole;
a front ring comprising a larger bore and a smaller bore in communication with the larger bore, wherein the front ring is inserted in the rear non-circular hole;
a rear ring comprising a passageway, wherein the rear ring is inserted in the rear non-circular hole;
a spring inserted in the rear non-circular hole and compressed between the front and rear rings;
a mandrel comprising a section fitted in the smaller bore of the front ring and another section inserted in the passageway of the rear ring; and
a magnet fitted in the larger bore of the front ring, wherein the magnet is adjacent to the mandrel, thereby magnetizing the mandrel through magnetic induction.

2. The screwdriver adapter according to claim 1, wherein the rear ring is made in one part with the non-circular rod.
